(19) United States
(12) Patent Application Publication
(10) Pub. No.: US 2014/0173638 A1
(43) Pub. Date: Jun. 19, 2014

(54) App Creation and Distribution System

(71) Applicant: Thomas G. Anderson, Albuquerque, NM (US)

(72) Inventor: Thomas G. Anderson, Albuquerque, NM (US)

(21) Appl. No.: 14/168,012

(22) Filed: Jan. 30, 2014

Related U.S. Application Data
(63) Continuation-in-part of application No. 13/705,159, filed on Dec. 4, 2012.
(60) Provisional application No. 61/759,842, filed on Feb. 1, 2013.
(60) Provisional application No. 61/730,554, filed on Nov. 28, 2012.
(60) Provisional application No. 61/566,756, filed on Dec. 5, 2011.

(51) Int. Cl. G06F 9/54

(52) U.S. Cl. CPC G06F 9/54
USPC 719/320

(57) ABSTRACT

A system for creating and distributing apps on computing devices. The present invention includes methods for allowing users access to apps and content by entering access information and methods to effectively create apps and content.

### CROSS REFERENCE TO RELATED APPLICATIONS

This application is a continuation-in-part of U.S. Ser. No. 13/705,159, filed Dec. 4, 2012, and thence to U.S. provisional applications 61/566,756, filed Dec. 5, 2011, and 61/730,554, filed Nov. 28, 2012. This application claims priority to U.S. provisional application 61/759,842, filed Feb. 1, 2013. Each of the preceding is incorporated herein by reference.

### BACKGROUND OF THE INVENTION

The present invention is in the technical field of apps that are used on a computer such as a tablet, phone, PC, laptop, or any other type of computing device. There are a great variety of apps developed and distributed for mobile and other computing platforms. They are often distributed on app stores such as the Apple App Store, The Amazon App Store, or Google Play as examples, for devices like the iPad, Kindle Fire, Nook, or Android tablets and phones, or personal computers, laptops, or netbooks. Apps can range across a variety of categories and genres such as games, education, business, entertainment, finance, reference, kids, books, lifestyle, medical, music, news, photo, productivity, social networking, sports, travel, and utilities as examples. The ways that apps can be distributed are limited, though. Also, it is difficult for developers to get customers to find their apps. There is a need for alternative ways to market, sell, and distribute apps.

### SUMMARY OF THE INVENTION

The present invention is a system that allows for the creation and distribution of apps. The system includes methods to implement and sell apps, methods to download and/or unlock apps, methods to increase visibility of apps, methods for users to generate or modify content, and methods to make apps more appealing and useful for users. The present invention can be useful in connection with the inventions incorporated by reference above.

### BRIEF DESCRIPTION OF THE DRAWINGS

FIG. 1 is a schematic illustration of an example embodiment of the present invention.

FIG. 2 is a schematic illustration of an example embodiment of the present invention.

### DETAILED DESCRIPTION OF THE INVENTION

The present invention provides a system for viewing, interacting with, distributing, unlocking, and transmitting interactive apps, interactive content, and related information. Interactive apps, digital books, eBooks, games, and other apps can be transmitted to an electronic device such as a tablet, phone, or computer, as examples, and can then be read or interacted with on the device. A user can touch the screen on the device, use voice commands, or interact with an input device such as a mouse to interact with the app, as examples. The present invention allows for apps to be sold and distributed through app stores, such as the Apple App Store, the Amazon App Store, Google Play, or other app stores, as well as be sold and distributed outside of the app stores through custom web sites, through codes or other unlocking mechanisms associated with or printed on physical items, or through other means of transmitting access information and ownership information electronically. For example, a code that allows access to an app can be printed on a retail gift card, on a retail post card, on a plush toy, on a greeting card, in a kid's meal at a restaurant, bundled with hardware, embedded in a QR code, embedded in a web link, emailed to a customer, embedded in a custom URL for an app, or distributed through an online store, as examples. Codes or other access information can be transmitted or entered into an app which can then download the purchased app into a player app, unlock the purchased app, unlock data within another app, unlock purchasable content in other apps, or otherwise allow access to an app or other data as examples.

An example embodiment of the present invention includes an application on an electronic device, a Controlling App (CA), that controls delivering apps or information or content or data of any kind to a user. The information to be delivered to a user or otherwise have access allowed for a user, can be purchased outside of an app store, or otherwise be allowed access outside an app store. The CA can be a user's means for utilizing apps of any genre or type, or a CA can be specifically designed for a specific type of app or a specific genre of games. The CA can have the app included within it, or it can separately download the app or data, or it can separately allow access in general. For example, a CA can be used for unlocking all games and apps, downloading all book apps, unlocking or downloading only match 3 type games, or unlocking or downloading only infinite-runner types of games, as examples. It can also be a portal to implement all purchases, no matter the genre or type, and it can communicate with other CA's that are more genre-specific. A CA can itself be downloaded from an app store such as the Apple App Store, the Amazon App store, Google Play, or any other app store, or it can be downloaded to a PC or Mac computer, or it can be presented through a web browser as other examples. Executables, packages, or installers for a CA can also be directly downloaded and installed by a user outside of an app store. The same user can use different CA's on different devices, but access the same app content. For example, if a user has an Android device and an iOS device, he or she can download the same or similar CA's from Google Play and the Apple App Store respectively, and then use the respective CA's to utilize apps available to the user or the user's online account. A CA can be implemented with user accounts, without user accounts, or with both options. For example, a CA can allow access to apps purely based on codes that are entered, or a CA can utilize a user account that a user logs in to, which contains information about available apps, or a user can have both options. A user's account information can include information such as user id, password, email address, physical address, indications of which apps or content have been purchased, indications of which apps are temporarily accessible through borrowing, lending or distributing features, user preferences, user customizations, user details, devices using CA's, social networks, or any other information used in online user accounts. The content or apps that are available to be utilized in a CA can be downloaded into the CA itself or it can be accessed as a standalone app on the device outside of the CA, or it can be accessed in both ways. Once an app presented to a user through a CA is downloaded, installed, or unlocked its functionality can be used by a user. A CA can include a user interface for utilizing apps that have been purchased, a user interface for viewing apps that are available to be purchased or downloaded, and other user interfaces for other functionalities such as creating one's own app, creating app information or data, creating other information and data, logging in to a user database, reading reviews or other app information, or social interactions with other users such as links to online social networks like Facebook or Twitter or other communities, as examples. A CA can interpret app information that was installed with the CA or which was separately downloaded to present to a user app elements and interactions such as game play, utilities, text, images, music, sounds, options, interactive objects, narration, animations, interactive choices, or any other information or functionality related to utilizing an app. A CA can also be implemented in a broader sense, where a single CA can be used to unlock codes for any genre in other apps or other CA's.

An example embodiment of the present application includes a Controlling App (CA) which is used to unlock other apps. A CA can be free to a user, for example, or it can be a paid app. The CA can be downloaded to a device through an app store, or otherwise be installed on an electronic device. The CA can have an area where codes can be input or it can receive app input information through custom URL information, QR codes that are scanned by the app, information downloaded from an online database or other ways of generally communicating information to an app. The information presented to a CA can indicate that an app, or Available App (AA), is available to be used by the user. The CA can allow access to the AA in a number of ways. Upon receiving the transmitted access information, the CA can begin a download and installation process where information for the AA is downloaded into the local file structure of the CA. The AA can be indicated to a user as available to be accessed through a library or collection type of interface such that all the available apps are shown in a user library or collection. Alternatively, an AA can be downloaded to its own directory structure and installed on the electronic device. In this situation, an indicator in a library or collection interface can still show the app. Alternatively, an AA can be purchased separately in an app store, and a library interface can detect that it was installed and show it as available to be used. Access information can refer to one AA when used on a specific type of computing device and a different AA on a different type of computing device. The AA's on each device can be the same, similar, or can be materially different. A Master Controlling App (MCA) can receive access information and check the availability or installation status of another app—a Specific Controlling App (SCA). The MCA can indicate to a user that the SCA should be downloaded and installed if it is not already installed. If the SCA is already installed, the MCA can transmit information to the SCA indicating that features should be unlocked in the SCA, that information should be downloaded and installed in the SCA, or that the SCA should otherwise install or make available an application, so that an AA is then presented to the user. Similarly, an SCA can communicate with an MCA to determine if an AA or other content should be made available to a user. The SCA can communicate with an MCA when it is first started, or it can communicate with an MCA upon a user indication, such as a button that is pushed to check if content is available, as examples. An SCA and MCA can communicate through a number of methods as described in the specification. One type of communication can occur through custom URL's where a first app can cause a second app to start with information that is passed to the second app. The information can include, for example, a request relating to access information. The second app can use communications to communicate with the first app. For example, the second app can receive the first communication, process the communication, and return control to the first app with new communication information, such as an indication on whether to make an app available to a user or not. An MCA can have different primary functionality than an SCA. For example, an MCA can host a library, store, and code entry system for accessing AA's where an SCA can have a primary purpose of implementing a certain type of AA. An SCA can have MCA functionality, though. For example, an SCA can have its primary functionality to implement a specific genre of AA's, but also have the library, store, and code entry system of an MCA. MCA functionality can be embedded within an SCA or AA.

An example embodiment of the present invention includes a Master Controlling App (MCA) that can unlock any number of Available Apps (AA). The MCA can receive inputs from the user indicating that an AA is available to be used, such as a code that is entered by the user or a web link that communicates with the MCA code information or unlocking information, or any of the additional techniques described in the present invention for unlocking AA's and transmitting access information. After receiving a code or other type of unlocking information, the MCA can then access a database and determine which AA should be unlocked. The database can be contained online or it can be contained within the MCA as examples. The database can also include the method for presenting the AA to the user or the method can be built into the MCA. After determining the AA and determining the method for allowing access to the AA, the AA can be presented to the user.

An example embodiment of the present invention includes an MCA that determines an AA should be presented to a user or otherwise have access allowed. The MCA can communicate with a SCA to allow the user to have access to an AA. After determining that the AA should be available to the user, the MCA can check if the appropriate SCA is already available on the electronic device. If the SCA is not available or is not already installed, then the MCA can present instructions to the user how to install the SCA. The MCA can also present instructions to a user on what to do after the SCA is installed. An SCA can be installed like any other app, whether through the app store or through other methods. For example, an MCA can receive a code or other access information for an AA which is a game. The game can be any genre of game, for example. After determining which specific game the code relates to, the MCA can check the electronic device if the SCA for that genre of game is installed. If the SCA is not installed the MCA can indicate to the user how to install the SCA such as by directing the user to a download page on an app store, by downloading and installing the SCA directly, or through any other means that an app can be installed. The MCA can also indicate to a user instructions on what should be done after the SCA is installed. For example, the MCA can indicate that a user should re-enter the code or other access information after the SCA is installed, either through the MCA or in the SCA. Alternatively, the MCA can automatically implement the ability to access the app by monitoring the installation progress of the SCA, by installing information that the SCA accesses after it is installed, or through some other communication means where the MCA indicates to the SCA that an app should be available after the SCA has been installed. If an SCA is already available, or after it is available, the MCA can send information to the SCA, such as through a custom URL, a shared file, shared online information, a shared database, an online database, or other means, that the AA should be made available to the user. The SCA can then utilize that information to allow a user access to the app. For example the SCA can download information about a game, such as game content or game levels. The SCA can download the AA itself. The SCA can allow in-app content to be made available to a user. The in-app content can be available to purchase separately in an app store, for example, directly through the SCA even if the MCA is never accessed, or the MCA can indicate that the SCA should allow access to the in-app content. Access information can take a variety of forms. It can be implemented, for example, as a code a user inputs into a CA, a web link with information embedded into it, information relating to what AA should be downloaded, where AA content is located, passwords to access protected content, a QR code with data that tells a CA how or where to access content, or any other means with which a CA can determine if and what data or what apps should be presented to a user and be allowed to be utilized. An MCA can communicate with an SCA and an SCA can communicate with an MCA based on various events, such as the start-up of the app, a time interval, a user generated request, a server generated request, or any other type of event. An MCA to SCA communication can implement app availability over time. For example, upon startup an MCA can check if any SCA's are available, access a database of available apps in a user account or internal record, and then give an indication to any SCA's that the apps should be made available to a user. This can be a useful method when an SCA is being installed or is installed at some point after an app is initially indicated as available to a user. Similarly, upon startup an SCA can check if an MCA is available and request app availability information upon startup. Communications can be implemented as custom URL communications, shared file communications, implemented through user account information, or any other app to app communications methods.

An example embodiment of the present invention includes more than one Controlling Apps. All of the CA's can utilize unlocking information through a consistent interface irrespective of whether the Controlling App is an MCA, an SCA, a CA, or an AA. The consistent interface can be a branded interface, such as a universal code entry area available in all apps in the system, or a universal method of communicating access information available to all apps in the system, as examples. Every app, irrespective of its main purpose, can handle the access information and act as an MCA, SCA, or CA to allow access to an AA. For example a Master Controlling Application can be designed as the main app that users are intended to enter codes or other access information. A user may, for example, instead enter the access information into an SCA associated with application types different than the app that will become available using the access information. In that case, the SCA can act as the MCA and communicate with a different and appropriate SCA for that code. In this way, users can get access to apps in different ways using whatever apps are currently available to receive access information.

An example embodiment of the present invention includes an SCA that is freely downloadable from an app store. The SCA can include in-app purchases, in which a user can purchase added levels, content, in-app currency, or any other type of functionality related to the primary purpose of the SCA. For example, the SCA can be a game or a collection of games in a specific genre. The SCA can unlock the in-app purchases through purchases directly implemented in a device's primary app store, or it can unlock the in-app purchasable content through any of the methods described in the present invention, such as the entry of a code, communications with an MCA, or any other method described in unlocking content.

An example embodiment of the present invention includes an alphanumeric sequence of characters which is used as the access information for content accessed and made available by a CA. The alphanumeric sequence, which can be thought of as an access code, can be entered by a user in a text input box, embedded in a QR code, embedded in a web link, embedded in a custom URL for an app, or otherwise be encoded into a computing device readable format.

An example embodiment of the present invention includes a code entry system that is used to make an app available to a user. A code can consist of a series of numbers, letters, and special characters, for example. A CA can have a clearly indicated code entry interface, where a code can be input. The code entry interface can allow a user to type in a code, which indicates which app should be made available to a user. The user can directly type in the code into the code entry interface, or the user can enter the code by clicking on a web link, scanning a QR code, transmitting access information in a custom URL associated with an app on a device, talking into an audio input device like a microphone, or otherwise inputting information or data. After a code is entered the CA can access a database to determine if the code is valid. A code can unlock or otherwise make available an app or app information associated with a CA, or a code can be linked in a database to an app or app information that is then downloaded by the CA or by a different CA.

An example embodiment of the present invention includes a CA that does not have a user login to login to a user account. The CA can unlock an app or otherwise make an app available purely through access information communicated to the CA, where no personally identifying information is stored by the CA.

An example embodiment of the present invention includes a CA that has a library component, where the library component shows a user all of the available apps or other forms of content that can be accessed. The CA can scan the memory or file system of an electronic device, for example, to determine what apps or content is available. A CA can use custom URL's to determine other apps that are available. A CA can communicate through custom URL's, files, user accounts, online databases, or other app to app communications with other CA's or AA's to determine which apps or content objects are available. A CA can maintain a database or access a database of apps and other content items that are potentially available to a user and include in the library representations of the apps or content items that are available. Representations can indicate that content is immediately available, available upon downloading data, or available upon other criteria such as a purchase or by joining a subscription plan. As an example, a CA can include information in its library database about an app that a user can access in conjunction with the CA. If the user purchases the app in an app store, for example, the CA can utilize a custom URL associated with the app to determine if it is available to the user, and if it is, a library icon can be used to both indicate the app is available and to change focus to that app. The app, in turn, can include an icon that returns the user to the CA or to an SCA or MCA. Alternatively, the user can purchase a code or other access information to internally download the app within the CA. In that case the CA can download information related to the app, make it available to the user through methods described in the present invention, and include an icon in the library to access the internally downloaded app. The icons for accessing a separately purchased app or an internally downloaded app can be the same or similar, leading to a seamless user interface experience by a user.

An example embodiment of the present invention includes an app with additional content or functionality that can be made available to a user. For example, the app can have in-app purchases. The app can detect the status or presence of another app including concepts like download status, installation status, or purchase status as examples, and based on the status or presence of the other app, make its own additional content available to a user. For example an app that allows a user to have access to artwork can sell the artwork as in app purchases. The app can also check if other apps are installed, for example through a custom URL or any other communication technique, and if they are, make portions of the artwork available in lieu of an in app purchase. Any type of functionality or content can be made available in an app by checking the status of other apps.

An example embodiment of the present invention includes streaming of information or data to a CA. The streaming of information can replace downloaded information to a hard drive, a flash drive, or other more permanent memory. The streamed information can be held in RAM, for example, or contained in some other temporary type of storage or memory. As an example, in the situation where a CA is used to allow access to book apps, each page of a book can be streamed to the CA on the device from an online server or other network communication, as the page is needed. Streamed content can have access restricted other than during an allowed session, to help prevent theft of the data. The streamed content can be encrypted and can also be deleted off of the electronic device after it is utilized by the user to help protect from theft of the data. As another example, app content can be streamed to a CA as the content is needed. The app content can be information and graphics related to a game the user is playing, for example. A game's processes, graphics, and control can be implemented on a server. After a user obtains access to an app, a CA can stream the graphics for a game to an electronic device so that the user can play the game. The user's inputs to the game can be sent to the server to control the game, where the game is being run on the server.

An example embodiment of the present invention includes streamed movie or video data accessed with a CA using access information. For example, a user can input a code or other type of access information into a CA. The code or access information can be verified as valid and can be associated on a server with movie or video information. Once the code or other access information is validated, the movie or video information can be streamed to the CA. Alternatively, the movie or video information can be downloaded to the user's electronic device to be utilized offline.

An example embodiment of the present invention includes similar CA's that are available on different hardware platforms. For example, similar CA's can be made to work on different operating systems, such as iOS, Android, Windows, or Mac OS. A similar CA can have a similar or even identical user interface irrespective of the hardware platform or operating system. In this way, users can get access to an AA using access information irrespective of the hardware platform they own or use. A single purchase of an app, and its related access information, can also be made available on multiple hardware platforms, for example.

An example embodiment of the present invention includes a CA that utilizes access information to allow users to be able to access an AA. The CA can include within it the primary functionality needed to implement an AA. For example, if an AA is a physics puzzle game, the CA can be developed so that it can run physics puzzle games such as the AA. The CA can receive access information and determine if the AA should be made available to the user. If the user should be allowed access to the AA, then the CA can download details about the AA such as level design, graphics for characters in the AA, physics constants or properties in the physics simulations, user interface components, information related to social networking aspects of the AA, sounds or music for the AA, or any other information needed to implement the AA. The programmatic control of the AA can be compiled within or otherwise embedded within the CA, and the data for the AA can simply be assets or parameterized aspects of the AA, for example. Another example of CA used to make an AA available to a user is a CA that implements book apps. The AA can be a specific book app, and the CA can be a book app player. The CA can download all of the assets for the AA book app, but the control and interactions with the book app can be controlled by the CA and the CA can simply download structure information and assets of the book app AA.

An example embodiment of the present invention includes a CA that utilizes access information to allow users to be able to access an AA. The CA can include within it all of the data needed to allow access to the AA. For example, the CA can be a free app on an app store with limited functionality. A code or other type of access information input to the CA and verified to be valid to allow access to the AA can unlock the AA's functionality within the CA.

An example embodiment of the present invention includes an app used to create other apps or content, a Content Creation App (CCA). A CCA can be used to create content from scratch, to import content and collect it into an app or other content, or can be used to customize other apps and content, as examples. This Created Content (CC) whether it is an app, a book, a book app, a game, levels in a game, shared information between users, news, customizations for a game, customizations for an app, variations of an app, or any other type of data or information, can then be shared using the methods in the present invention. For example, a user can use a story creation app, which is a CCA. It can be used to create books or book apps, where the CC is a book app. As another example, a CCA can be used to customize a match 3 type of game, choosing which backgrounds are shown on the screen, which items are presented to be matched, what layouts are used on each level in a created game, what different types of effects happen with different types of matches, what powers or abilities a user has in matching items, or any other type of modification or customization a user can make to a match 3 game. As another example, a CCA can be used to develop, create, or customize an infinite runner type of game, where the user determines the terrain and graphics the runner runs on, the types of rewards the runner tries to gather, the types of movements the runner can make, the types of obstacles a runner must overcome, the layout of levels in the game, or any other details associated with designing an infinite runner game. After a CCA is used to create the CC, the CCA can present a user with a download code or other type of access information that can be used by other users to access the CC. The CCA can upload the CC or information representing the CC to the cloud or to an online server, as examples, so that it can be accessed by other users, or it can package the CC into a file or set of files that a separate CA can use to allow access to the CC. The CCA can update a database associating the code or other access information with the uploaded or otherwise made available CC. After CC is created, therefore, it can be shared by users, sold to other users, or otherwise be distributed to other users, using a CA and access information. Codes or other types of access information can be provided to a user from a code generator or an access information generator, or from a pre-existing list of codes or other type of access information. Alternatively, codes or other types of access information can be user generated. A user named Tom, for example, might create a book and request the code “Tom's Book” as the code that allows access to his book. The CCA can verify if requested access information is valid and available and if it is then associate it with the CC to be able to share it with other users.

An example embodiment of the present invention includes a CCA that is used to create CC. The CCA can then be used to access online storage by a third party, such as Dropbox. For example, a user can enter his or her Dropbox login information. The CCA can then save the CC into the user's Dropbox account. Further, the app can then create a code or other type of access information, or obtain a code or other type of access information from an online database or online server, and then associate the code with the saved CC so that other users can utilize the access information stored in the user's Dropbox or other kind of cloud storage account. The CCA can be used by the user to set the proper permissions in the cloud storage account so that the data can effectively be accessed with the proper permissions. The proper information needed to utilize the permissions and the associated access information can be associated in the database such that a CA on another user's electronic device can gain access to the CC using the access information.

An example embodiment of the present invention includes an app that has a story creator component, an online store component to buy or download digital books or book apps, and a library component that shows which books have been created or bought. In this example embodiment, the app can be used as a CA, as it can include a download code button with which a download code can be entered to download digital books. When a code is entered, the app can communicate information to a server which can determine if the code is valid, how many times it has already been used, what digital book is associated with the code, and other information related to making a digital book available to the user. The digital books can be presented to a user as book apps where there can be a large amount of interactivity not available in a typical eBook, such as animated characters, record-your-own-narration features, page turning effects, choose your own adventure types of stories, or other advanced book features. The app can have a beginning user interface that lets users buy or download books, read books, or create books. The download books choice can take a user to a store component, where available books and their respective prices, if applicable, can be presented to a user. The read books choice can take a user to a library component where the user can see all the books that have been purchased, downloaded, created, or otherwise gained access to. The create books choice can take a user to the story creator component where the user can create, design, modify, or otherwise create or modify book content. Books, book apps, or other types and forms of book content, or any type of content presented in the book analogy, can be created with the story creator component. Books or related data or any CC can be shown in the library component once it is created. Content shown in the library component can be accessed by clicking on a representation of the CC or otherwise interacting with a representation of the CC. The story creator component can dynamically create access information for CC. For example, after a book is created, a user can push a button labeled share, publish, or some other similar type of indicator that allows content to be distributed to other users. CC can then be uploaded to a server, the name and location of the CC can be entered into a database. A code can be generated or accessed from a list of existing codes, and that code can be associated in a database with the CC. Then other users can utilize the code or other form of access information to download the CC to their app, which can be shown in their library. Many codes can be delivered to a user, by purchasing them, purchasing a subscription of some form, or otherwise gaining the ability to get multiple codes, and the codes can all be associated with the CC and can be sold to other users, effectively creating a method of distributing or selling a book through the app. Additionally, CC can be added to the store component and can be accessed or downloaded in that way rather than through a code mechanism or other form of access information. A store and its content can be consistent across all users and all hardware platforms and operating systems of the app, or the store and the way that the information is presented can vary per user, per OS, per device, per device type, per user preferences, or any other information available to the app.

An example embodiment of the present application includes an app comprised primarily with story creator functionality or with a story creator component, where a user can place or manipulate content to create a story, book, book app, or similar book related information or story type of information. Where books are described in the present invention, this can refer to any of these types of information or it can refer to information or data that is presented simply in a book or multiple page analogy, so that any type of information such as news, magazines, videos, user to user texts, messaging, pictures, photos, or any other type of information can be created, shared, distributed, saved, or otherwise interacted with. The story creator can allow a user to place backgrounds on pages in a digital book or book analogy. Backgrounds can be placed for a large library of content on the electronic device, available from the cloud or online servers, available through other third party distribution such as Dropbox or Shutterfly, or from a device's camera, pictures, or camera roll, as examples. The app can adjust the page's background dimensions to fit any background placed on the page. The app can also allow a user to place other objects or images onto a page or associate with a page such as plain images, images with alpha representations, animations, movies, event objects, user interface objects, text, sounds, music, or any other type of data that can be presented to a user. The user interface for the story creator can access any of the data, formatting, assets, or structure of a book app. Pages can be ordered so that a user can move through them in order, or objects can be placed allowing a user to go through the pages in differing orders. For example, a book can be created so that an end user reading the final book can choose his/her own adventure through a book. Similarly, a book can be created with news information, where different user interface elements take an end user reader to different pages of the book which contain different types of news. The pages can simply be a representation where different types of news are on different pages.

An example embodiment of the present invention includes an app with a story creator component where the story creator contains a user interface with a background insertion button, a character insertion button, and an object insertion button as three of the primary components in allowing a user to add content.

An example embodiment of the present invention includes a CCA where the app has 3D generated scenes and/or 3D generated characters. The story creator can be used to modify the camera angles within a scene and/or modify the positioning, scale, orientation, relative orientation, and other aspects of the 3D objects within the scene. Then the CCA can be used to convert the 3D scene into a 2D image which is used as content inserted by a user using the CCA.

An example embodiment of the present invention includes an app with a story creator component where the story creator contains a user interface with a method of inserting backgrounds as a primary component, where the backgrounds determine the ways that pages are laid out and displayed on the device, and a separate set of components for adding foreground images and objects over the background.

An example embodiment of the present invention includes an app with a story creator component where the story creator contains one or more templates from which a user can create book content. Templates can include a layout for a specific type of literary concept such as Joseph Campbell's Hero's Journey, a typical layout for a story, typical layouts for a comic book, layouts for news, structures for a school project or presentation, a layout for social interactions like texting, messaging, sharing pictures, interacting with social media accounts like Facebook or Twitter, layouts for creating scrapbooks, layouts for creating vacation memories, layouts for creating children's books, layouts for creating presentations, layouts for creating eCards, or layouts for any other type of document or content. Templates can also include randomization features, where scenes, locations, characters, or other story concepts are randomly generated and presented to a user to help being with the creation of a story. A user can select a template, and the template can be loaded and then modified by the user. A page selection area can be used to further modify a template or modify book content. Pages can be deleted, moved, renamed, selected, or otherwise modified or accessed in the page selection area.

An example embodiment of the present invention includes an app with a story creator component where there is a large library of artwork available to the user to create book content. The library of content can be accessed through a folder system or through a database that presents the content in a structured way. For example, content can be presented to a user categorized in different categories. The content can be separated into primary categories such as backgrounds, characters, objects, and music as examples. Each category of content can be further categorized such as by location, theme, type, or any other characteristic of the content. For example, the app can have a primary toolbar with buttons to import backgrounds, characters, objects, and music. Other high level categories can be added to the toolbar such as a button to import accessories or sounds. The primary toolbar can include placing other components such as page text, text boxes, recorded narration or the ability to record narration, or other book content as examples. When content is accessed, it can be filtered by an active theme. The theme can be chosen by selecting a section of an image, such as a picture of a princess to enable the princess theme or a picture of zombies to enable a monster or zombie theme. The content that is available to a user can be adjusted based on a theme or there can be no theme. For example, a set of available background images can be filtered so that only princess related background images or monster related background images, as examples, are shown while the princess or monster theme are active. Themes can remain consistent in how they filter content whether selecting backgrounds, characters, objects, or other types of content. A search component can be added to content as well. Content images or folders can be associated with keywords or other text, and a search feature can be used to only bring up relevant images. The images that are shown as available can be filtered by theme, search, image type, or any other characteristics of the images, or any combination of filters and categories.

An example embodiment of the present invention includes an app with a story creator component where the story creator allows a user to place content over a background. When the placed content is selected, a toolbar near the content can be shown to further adjust the content. For example, user interface components can be placed near the content, and move with the content as it moves, to adjust its scale, size, position, color, photo filters, icons to bring up other user interfaces such as image manipulation and management, depth relative to other objects, activation criteria, characteristics (such as font, alignment, font size, etc. for text), or any other properties of the objects. These objects can be implemented as event objects, where an event triggers some type of animation or interaction. Often these types of controls are shown in side toolbars, but by having the interface appear only when an object is selected, screen real estate can be saved and a screen can be less cluttered. An object can be implemented so that it can be moved without showing the object's UI for additional modifications. When an object is touched, it can be selected for additional modifications and the object adjustment UI can be shown. A movement icon can be included in the object adjustment UI so that it can be moved while it is selected, and when it is selected clicking and dragging can perform another action (such as highlighting text in a text object). A delete icon can be included in the object's UI as well.

An example embodiment of the present invention includes an app that is a CCA or with a CCA component. The CCA can be used to create any type of CC that can be used in an app including an app itself. The app can give a user the ability to share content with others or otherwise publish or distribute the content. The app can allow the user to choose whether other users can further modify the content so that when the CC is downloaded by a CA, for example, the CC includes data that allows the app to access and modify the CC. In this way, users can work on collaborative projects where one user starts the creation of the CC and other users can contribute, add to, or modify the CC through the CCA. For example, multiple users can work on a presentation, two children can create a book together, a grandmother can record narration for a book for a grandchild which the grandchild wrote, or any other number of shared and collaborative interactions.

An example embodiment of the present invention includes an app that is a CCA or with a CCA component where eCard content is created. The eCard CC can be created by laying out background images with foreground images and adding text, or it can be created by card templates where a user fills in a limited set of information to customize an eCard before sharing it through a CA.

An example embodiment of the present invention includes an app that is used to share texting information or images or other shared communications. A user can create a shared set of content, where one or more users can add to the content. For example, a representation of a texting session can be implemented as an icon in a library type of interface, or in a list of texting sessions in general. Once a user starts a texting session, a CCA can provide the user with a code or other type of access information that allows others to access the texting session. Different codes can be distributed that allow different levels of permissions for the texting session. For example, one code can allow users to read the texting session, but another code can allow users to read and write into the texting session. By using codes to allow access to a texting session, users can communicate with each other without the need for user accounts. A CCA can allow users to add text, images, or any type of information including complex book app interactions or game interactions and design and development without ever taking any information that can be used to identify the user that created the texting session or other shared data or any of the users accessing or modifying the data. A texting session that is started by a user, and which is shared with a code or other access information can be saved on a server, and the location and details of the data can be maintained in a database that associates the code or access information with the data. Because the data can be downloaded to a user's electronic device, the data can be saved on the server for a finite period of time or it can be saved only until a user or a set of users have accessed it. Data can also be deleted at any given time from the server, from a user's device, from devices of user's with certain privileges, from all users, or any combination of deleting data, based on user preferences or settings associated with the texting session. For example, a user can set a texting session where all information is deleted an hour after it is posted, or a user can post a picture and indicate for that picture only that it should be deleted 5 minutes after it is posted or five minutes after it is first seen or a combination of timing from different events. A CA can request updates on information from a server, so that as participants in the texting session append the conversation with their text, images, and other data, everyone who is a part of the conversation will get the current and updated information and data associated with the texting session. A set of data that is shared among multiple users, and where multiple users can modify it at the same time can be implemented with protections so that the data remains valid and intact even when multiple users modify it at the same time or near the same time. For example, a dataset can be set to be checked out to a single user at a time. Alternatively, a dataset can be appended by multiple users, and the dataset is adjusted as multiple people add to it even if they add to it at nearly the same time. Alternatively, a dataset can be combined from multiple versions of the dataset modified by various users, and any discrepancies or conflicts created by multiple users modifying the data at the same time can create warnings for the users. A texting session is only one type of information or exchange that can be used in this example embodiment of the present invention, and the concepts apply to any type of CC.

An example embodiment of the present invention is a jointly created dataset such as a book or presentation. A first user can utilize a CCA to begin the development of the CC, and obtain access information from the CCA, such as a code. The first user can share the code with one or more other users, and the CC can be set by the first user to be modifiable by other users. The other users can enter the code into the CCA (therefore the CCA can act as a CA in that case), and get access to the CC. The users can use the CCA to further modify the CC. The CCA can then update the CC as it is updated by other users, and a consistent and updated version of the CC can be available to all of the users. The CCA can check for updates at timed intervals to make sure that the content is current or push notifications can be used to alert the CCA to new or updated content. As examples of implementations of this example embodiment of the present invention, two girls could write a story together taking turns creating pages in the story, or a business team can collectively add to a business presentation as the parts of the presentation they are responsible for are completed.

An example embodiment of the present invention includes a CA that utilizes access information to allow a user access to data. The data can represent an AA or it can be data of any other form. For example, the data can be a news feed, a Twitter feed, a collection of Twitter feeds, a conversation, a texting session, Facebook information, shared images, shared stories or books, or any other type of data. The data can be filtered based on user preferences. Once a user utilizes access information, for example such as by entering an access code, the information can be represented as an icon or some other graphical means, and can be included in a library or other list of data objects. For example, a library component of an app can include user interface objects that represent different sources of data a user is interested in, such as a Facebook object, a texting session, a conversation or communication, a book, a magazine, one or more Twitter objects, a news story, a news area, a game, an app, a calendar object, weather reports, stock reports, or any other type of data a user is interested in. After a code is entered and the representations of the data are shown in the library, the data can be updated over time, giving the user updated information and content. The methods utilized in updating the content can be adjusted by the code or access information used, database information associated with the code or other access information, or user preference. For example, a code can be input into a CA which then loads a world news object into the CA's library component. The world news object can be updated every 30 minutes, but a different code can load a world news object that is updated every hour. A user can adjust the preferences with that news object and have it update every 15 minutes. As another example, the various types of data a user can access can be combined with other concepts described elsewhere in the present invention. For example, a user can scan on a QR code to download a game within the CA, scan a separate QR code to get access to a texting session among friends, and input a download code from a card the user bought in a retail location which in turn downloads a book app for the user to read. The user can record narration for the book app in a CCA component of the app, create a new code in the CCA component for the book app with the recorded narration, and share that code with a family member who then gets the book app and the recorded narration by entering the access information (in this case a download code) into the CA on his or her device.

An example embodiment of the present invention includes a CA that can download information about an AA to make the AA available to the user, where the CA is downloaded from a server or a set of servers, or some other type of transmission system associated with an app store, and where the AA content is downloaded from a separate set of servers or transmission system unrelated to the app store the CA was downloaded from. For example, a user can download a CA from an app store such as the Apple App Store, the Amazon App Store, or Google Play as examples. The CA can then download an AA or AA content or specifications separate from the app store the CA was downloaded on. The CA can download the content without any interactions with the AA and can therefore be implemented outside of an in-app purchase system available in the app store. Additionally, a CA can have both sets of functionality, such that an AA can be available either through an in-app purchase or also available to be downloaded separate from an in-app purchase as the user desires.

An example embodiment of the present invention includes a CA that can download information and/or specification of an AA to make the AA available to a user, where the CA utilizes access information to determine if the AA should be made available to the user. As an example, the access information can be communicated to a server with a database of access information to determine if the access information is valid and to determine which AA is associated with the access information and should be made available. A CA can then access the same database or a separate database to determine instructions on how to download the AA, such as a file name or file location or URL associated with the file. The information used by the CA to access the AA data can include concepts such as the AA's name, the AA file size or package size, the name of a file or package, a URL where the data can be downloaded from, a path where the data can be downloaded from, encryption information, the version of the AA, details on where to install the AA such as directory path details or instructions on how to unpackage the AA data, or the number of times a package has been accessed or other information related to past usage of the data, as examples. The code information can be in the same database or in a separate database. For example, data related to codes can be implemented in a SQL database, and data related to download information can be implemented in a separated SQL database. Alternatively, the information can be implemented in the same SQL database, but in different tables, or the information can even be implemented in the same table but utilizing different columns or other structures in the table. Information related to access information can include a code name or other representation of the access information, user account data and information, an AA's name or indicator, the number of uses that access information can be used, the number of times access information has previously been used, and instructions or data for coordinating access information with a user's account, as examples. Access information that is utilized can be saved in a user account so that a user can maintain a consistent set of data of which AA's are available.

An example embodiment of the present invention includes two or more apps that all can implement the functionality of an MCA. For example an MCA can be used to install or direct a user to install SCA's. The MCA can include an indication of how to enter codes, for example, or have other ways of obtaining access information. Once an SCA is installed, it can be used to make AA's available, but it can also have the same ways of obtaining access information that an MCA has. Although the SCA can have a primary purpose other than being used as an MCA, by allowing access information to be entered into the SCA, or any other app in the network or collection of apps able to receive access information, users can have more flexibility and ease of use on entering access information. An SCA, CA, or AA can include the ability to receive access information. The SCA, CA, or AA can then have the same functionality as an MCA, for example by downloading a separate SCA, or the SCA, CA, or AA can communicate with the MCA to implement its functionality. A consistent interface for receiving access information can be implemented in all of the apps in the network or collection of apps able to receive access information.

An example embodiment of the present invention includes user account functionality that can be coordinated with making apps available to a user. For example, a user account can contain information on a device or on a server which shows which AA's are available to a user. User account information can include information such as the user's name, id, email address, physical address, credits for purchases, credits for unlocking functionality, social networking information, friends information, ranking and progress information, and information related to which CA's and AA's are available and under which circumstances, as examples. A user can purchase access information for an AA, and when the access information is utilized, the ability to access the AA can be saved in a user's account so that a user can log into another system or restore the same system later, as examples, and get access to the AA without needing to reenter the access information. An app purchased in an app store can unlock an AA in a user account. In app purchases can be recorded in a user account so that they can be restored or made available on a separate device. An online store can be implemented such that purchases made in the online store can be recorded in a user account and computing devices can then access AA's that are shown as available in a user's account. User accounts can maintain all purchase information a user takes part in, irrespective of how or where the purchases occur, and any device accessing the user account can make apps or information available to a user based on the user account information.

An example embodiment of the present invention includes a CA that is implemented in a social networking context. For example, a CA can be an app available to Facebook users as a Facebook app. For example, a user using the CA can gain access to an AA utilizing the same type of user interface one would use on a mobile device. A Facebook app implementation of a CA is similar in nature to a CA implemented on a different OS, for example. The CA can be implemented as a Facebook app, as an iOS app, as an Android App, as a Windows App, and as a Mac app, and provide users with the CA functionality on any of their preferred platforms. A CA can also have additional social networking functionality added to it. For example, information about an app can be shared with other users within a social network, game features and levels can be unlocked or downloaded or otherwise accessed based on social networking tasks such as sharing information, asking a friend for app access or feature access information, asking a friend to download or install an app, or other types of social networking activities.

An example embodiment of the present invention includes a lending feature, where a CA can receive access information originating from a different user's computing device. For example, a first user can receive access to an AA. That user can then indicate that a second user should receive access to the AA. The second user can receive access to the AA on a computing device. The access information can be implemented as a code one user gives to another user or as a state within a database on a server, as examples, or any other way that users can communicate with each other or computing devices can communicate with each other. Access to the AA for the second user can be limited in nature, such as limitations in availability over time or limitations in functionality or content access. Access to the AA for the first user can be limited while the AA is available to the second user, or alternatively, the first user's access can remain unchanged.

An example embodiment of the present invention includes a used app sale feature, where a user, or seller, can receive access to an AA and then indicate that the AA should be made available for purchase by other users in a sales system, where the AA then becomes a used app. A sales system can allow the sales of new apps, of used apps, or through a combination of the two. The seller can determine sales details, such as price, or the sales system can determine the sales details. AA's that are made available in the sales system can be purchased by other users. The sales system can provide a purchaser with access information allowing access to the AA and the sales system can remove access information from the sellers computing device, removing access to the AA. The sales system can coordinate data transfers with CA's to implement sales. A seller can receive payment in cash or credit to make more purchases within the sales system of either used apps or new apps.

An example embodiment of the present invention includes a CA that can provide a user with functionality to communicate with separate users' CA's. For example, a first user can receive a code or access information from a CA that is used to identify the CA and/or the user, or a user can link with coworkers, friends, students, classmates, family members, or people in other types of relationships through an online database or social network. The code or access information can be anonymous or it can be linked with user information. The first user can then distribute a code or access information, for example, to other users. Similarly an online database can communicate with the CA's from multiple users and link or connect users in a relationship to each other, where data can be shared. The other users can utilize the code or access information or social network information in their respective CA's, which can then be registered in the CA's. Sharing functionality in the CA's can then be implemented using the sharing information. For example, a teacher can give students a code such that when the code is entered, the student's homework can be easily uploaded to a server and then transmitted to the teacher. The code entered on a student's content creation app can indicate where on a server uploads should be stored, for example. Then the teacher's CA can access data in that location. A worker can share information with coworkers, family members can share information together, or any other group of people can share information together using this type of sharing information. The sharing information and functionality can adjust which content is accessed and which access information is available to a CA.

An example embodiment of the present invention includes apps that can be used to share data from one user to another. Apps that communicate the information can include sharing information which indicates which users can have access to which information. For example, a teacher can share school information with students. The sharing information in an app can include a reference to multiple users. Sharing information can be communicated to apps through the use of access information, for example. A teacher can utilize an app that has a roster, where student information for each student is entered into the roster, and the teacher can then share information with only students who are included in the roster. A teacher can share assignments or performance information, for example. Students can utilize apps that communicate with the teacher's app, for example, where data the students want to share is sent to the teacher. For example, students can complete an assignment using a CCA and then with the simple push of a button, the content can be delivered to the teacher based on the previously communicated sharing information. In this way, content can be easily communicated. As an example, a teacher can give students a teacher code generated by a CA, the students can enter the teacher code into a CA which links the teacher's CA to the students' CA, and then throughout a school year the teacher can provide students with assignments using CCA functionality in the CA, students can complete the assignments using their CCA functionality in their CA, students can publish their work back to the teacher where the data is sent to a server accessible by a teacher's CA and available to the teacher based on the original code given to students. The code can define a specific directory where files are to be uploaded to or the code can be used to associate accounts, as examples.

An example embodiment of the present invention includes a CCA used to create content, where a user can publish or share the content through a system that allows sharing. Users who desire to access the content can utilize a CA to access the content. When publishing or sharing information with other users, a user can indicate how the content can be shared. For example, a user can indicate that only friends in a social network can access content, that only users with access information can access the content, or the user can indicate that content can only be accessed upon a purchase and set the purchase price and purchase details.

An example embodiment of the present invention includes multiple users utilizing CA's to take part in a game, role-playing experience, a virtual reality experience, an augmented reality experience, a multi-player first person shooter, a massively multiplayer online game, or other shared experience. A user participating in the shared experience can indicate through the CA that a shared experience session should be joined. The CA's can coordinate communications to define the interactions of the shared experience. For example, CA's can communicate with a server to indicate that a user wants to join the shared experience, or one CA can control the shared experience and other CA's can communicate with it, as examples. CA's can communicate through an internet connection or through Bluetooth communications, as examples, or through other standard device to device communication methods. A server or a controlling CA, as examples, can then control the shared experience. A CA can utilize access information to join the shared experience. After a shared experience is started, the controlling device can send and receive data to and from the CA's. For example, a user can be assigned a role in the shared experience or a user can be assigned abilities or other functionalities or capabilities in the shared experience. The roles, abilities, functionalities or capabilities for each user can vary. For example, users can be assigned roles in a murder mystery game, or users can be assigned abilities in an augmented reality or virtual reality interaction. Users can know other user's roles, or the shared experience can be implemented such that users have limited knowledge of other users' interactions or roles with the shared experience. The experience each user has in a shared experience can vary. For example, in a role-playing game where users are assigned to be a particular character, a user can be presented only with information and choices that that character has in the game. For example in an AA where users are assigned roles, the presentation and data available in an AA can vary based on the assigned role. Users can be assigned roles and capabilities that require each person to perform a task or function, and the combined cooperation of users controls the pace of the progression through a game. Users can be assigned roles where they are in competition, or users can be assigned roles where some users have one task and other users have another task. For example, in a murder mystery game, a single user can know that he or she is the murderer in a game while all of the other users are trying to determine who the murderer is. Users can be assigned teams in a first person shooter, for example, or users can be assigned roles in a first person shooter where all of the users are on the same team fighting opponents with Artificial Intelligence and where each user has his or her own capabilities in the game. A controlling device can control the progression of the shared experience. For example, a group of users can be assigned a task in an augmented reality or virtual reality setting, or users can be taken through an interactive story, such as a murder mystery game or other type of roleplaying game. The content in an interactive experience can be implemented through methods described in the specification—for example, a shared experience can be implemented as an AA which is made available through access information utilized by a CA. The AA can be indicated in a library of AA's, for example, and joining the shared experience can be implemented by starting the AA within a CA's library. The control of the experience can vary depending on how many users join a shared experience and details of the users joining the shared experience. For example, a shared experience can be a murder mystery game where the storyline in the game is adjusted to accommodate different numbers of users. The characters in the murder mystery game can be adjusted, modified, or customized based on the sex of the users participating in the shared experience. Users can indicate in a CA that a session should be made available for other users to join. The session can be an open session for any other users to join over a broadly shared internet connection, or it can be limited to only users specifically invited to join the session. Users can join available sessions. For example, a group of users located in the same room can start an AA which is a role-playing game and indicate that a session is open to be joined, but only allow the users in the room to have the access information to join the session. Alternatively, a user can start a session open to anyone with internet access and access to the AA.

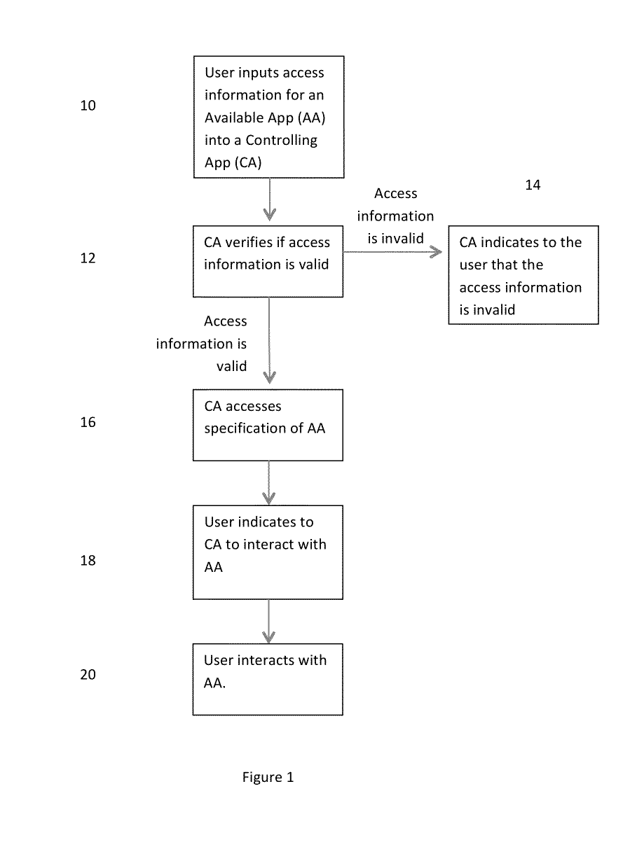

An example embodiment of the present invention is shown in FIG. 1. In this example embodiment a user inputs access information for an AA into a CA, 10. The CA verifies if the access information is valid, 12. If the access information is not valid, 14, the CA indicates to the user that the access information is not valid. If the access information is valid, 16, the CA then accesses the data and specification associated with the AA, or accesses a version of the AA, or otherwise makes the AA available to the user. The user indicates to the CA that he or she wants to interact with the AA, 18. The user can then interact with the AA, 20. Variations and implementations of the steps shown in FIG. 1 are described in the specification.

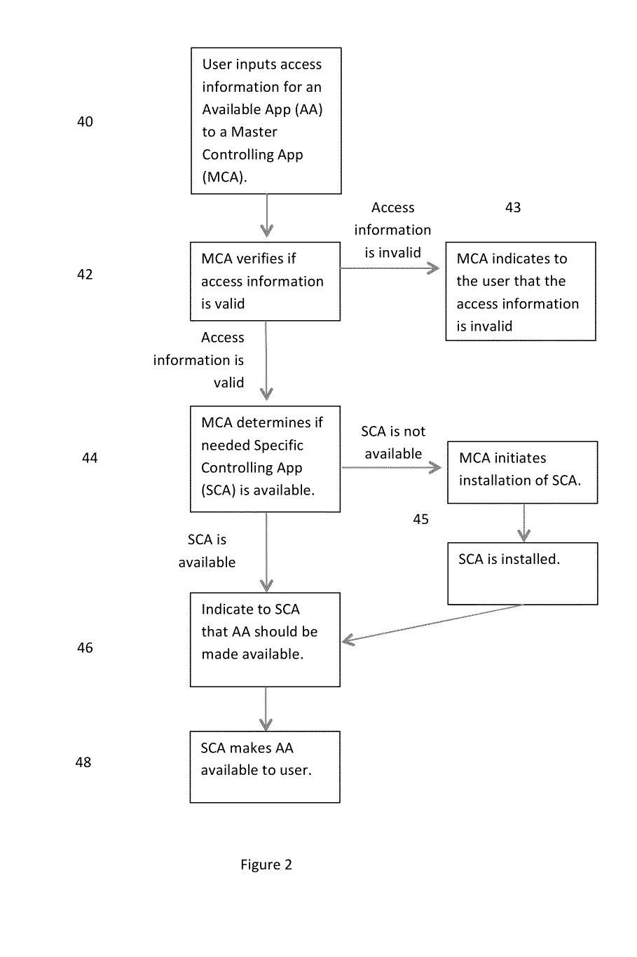

An example embodiment of the present invention is shown in FIG. 2. In this example embodiment a user inputs access information for an AA into an MCA, 40. The MCA verifies if the access information is valid, 42. If the access information is not valid, 43, then the MCA indicates to the user that the access information was invalid. If the access information is valid, 44, then the MCA determines if a needed Specific Controlling App is available. If the SCA is not available then the MCA initiates installation of the SCA and the SCA is installed, 45. If the SCA is available, or once it is available, an indication is made to the SCA that the AA should be made available, 46. The SCA then makes the AA available to the user, 48. Variations and implementations of the steps shown in FIG. 2 are described in the specification.

The present invention has been described as set forth herein in relation to various example embodiments and design considerations. It will be understood that the above description is merely illustrative of the applications of the principles of the present invention, the scope of which is to be determined by the claims viewed in light of the specification. In most cases, CA's, MCA's and SCA's can be used interchangeably, so the title should not limit the functionality. Descriptions of an AA can refer to the AA itself, or it can refer to content or functionality in an app, for example, so the term should not limit what types of content and functionality are made available to users. Other variants and modifications of the invention will be apparent to those of skill in the art.

We claim:

1. A method of providing interactive functionality to a computing device, comprising:
(a) providing a controlling app (CA) on the computing device, wherein the CA is configured to access a specification defining content and functionality of an available app (AA), and to interact with a user according to the specification, and configured to accept a code corresponding to an AA and access a specification corresponding to the code from storage;
(b) accepting from a user access information corresponding to an indicated AA;
(c) using the CA to access a specification corresponding to the indicated AA;
(d) accepting from the user an indication that interaction with the indicated AA is desired, and using the CA to interact with the indicated AA according to the corresponding specification.

2. A method as in claim 1, wherein the primary functionality of the AA is distinct from the primary functionality of the CA.

3. A method as in claim 1, wherein the specification defines functionality of the AA that includes at least one of control of logical flow through a story for non-linear storytelling; character animation; videos; sound effects; recording of audio input; implementation of touch interactions; implementation of tilt interactions; implementations of camera interactions; multiple available versions of a story or game; user controlled reading levels; parent protective controls; control of language implementation; words that highlight as a narration file is played; customizations in story text; customizations in story graphics; customizations in music, narration, or sounds; or customizations in gameplay.

4. A method as in claim 1, wherein accepting a code from a user comprises accepting a code manually entered by the user, scanning a bar code under control of the user, scanning a QR code under control of the user, accessing a code from a user account, accepting input from a magnetic strip reader, accepting a code communicated with near field communication, or a combination thereof.

5. A method as in claim 1, wherein using the CA to access a specification comprises using the CA to access a remote system configured to present the specification in response to the CA.

6. A method as in claim 5, wherein the CA is configured to access a database responsive to the access information, and to download the specification responsive to information in the database.

7. A method as in claim 1, wherein using the CA to access a specification comprises using the CA to access a remote system configured to validate access information presented by the CA, and allow access to a specification only upon presentation of valid access information from the CA.

8. A method as in claim 7, wherein the CA downloads the specification after validation of the access information.

9. A method as in claim 7, wherein the CA unlocks AA functionality that was previously present in the CA after validation of the access information.

10. A method as in claim 5, wherein the remote system is distinct from the system from which the CA is accessed or installed.

11. A method as in claim 7, wherein the remote system is distinct from the system from which the CA is accessed or installed.

12. A method as in claim 1, wherein accepting an indication from the user comprises completion of the CA access to the specification.

13. A method as in claim 1, wherein accepting an indication from the user comprises selecting an icon corresponding to the indicated AA from the computing device's customary app interface.

14. A method as in claim 1, wherein accepting an indication from the user comprises using the CA to select the indicated AA.

15. A method as in claim 14, wherein the CA is configured to present a plurality of AAs to a user, and to accept selection by the user of one AA from the plurality of AAs.

16. A method as in claim 15, wherein an AA is configured to accept an indication from the user to return control to the CA.

18. A method of providing content or functionality, or a combination thereof, to a user of a computing device, comprising:
(a) providing a master controlling app (MCA), configured to accept access information corresponding to an available app (AA), and configured to determine a specific controlling app (SCA) required for operation of the AA, and configured to initiate installation of the SCA if the SCA is not already present on the computing device;
(b) accepting access information corresponding to an indicated AA;
(c) using the MCA to determine if an SCA required for operation of the indicated AA is present on the computing device, and, if not, then initiating installation of the required SCA;
(d) using the access information to indicate to the required SCA that the indicated AA is available;
(e) using the required SCA to make the indicated AA available to the user.

19. A method as in claim 18, wherein primary functionality of the MCA is distinct from the primary functionality of the SCA.

20. A method as in claim 18, wherein accepting access information comprises accepting access information manually entered by the user, scanning a bar code under control of the user, scanning a QR code under control of the user, accessing access information from a user account, accepting input from a magnetic strip reader, accepting access information communicated with near field communication, or a combination thereof.

21. A method as in claim 18, wherein initiating installation of the required SCA comprises using the MCA to download the required SCA, using the MCA to initiate an app access facility configured to download or install the required SCA, communicating to the user instructions for downloading or installing the required SCA, or a combination thereof.

22. A method as in claim 18, wherein using the access information to indicate to the required SCA that the indicated AA is available comprises using the required SCA to accept access information from the user, using the MCA to communicate the access information to the required SCA, using the MCA to communicate to the user a code corresponding to the indicated AA and using the required SCA to accept the code from the user, using the MCA to communicate to the required SCA a code corresponding to the indicated AA, or a combination thereof.

23. A method as in claim 18, wherein the MCA communicates with the SCA to determine whether there are any AA for which the MCA has accepted access information and which have not yet been made available by the SCA to the user.

24. A method as in claim 18, further comprising maintaining a record of AAs in an account corresponding to a user, and wherein access information is obtained from the record.

25. A method as in claim 18, wherein using the required SCA to make the indicated AA available to the user comprises unlocking the AA within the SCA, downloading the AA to the SCA, or a combination thereof.

26. A method as in claim 18, wherein the MCA is further configured to serve as an SCA for at least one AA, and wherein step (c) comprises determining if the SCA required for operation of the indicated AA is present as part of the MCA or present on the computing device, and, if neither, then initiating installation of the required SCA.

27. A method as in claim 18, further comprising providing an SCA that is also configured to provide functionality of an MCA. 28. A method as in claim 18, further comprising providing an AA that is also configured to provide functionality of an MCA.
